(19) United States
(12) Patent Application Publication
(10) Pub. No.: US 2026/0336732 A1
(43) Pub. Date: Oct. 29, 2026

(54) PROCESS FOR MANUFACTURING A VEHICLE ACCORDING TO TWO MANUFACTURING CONFIGURATIONS AND ASSOCIATED SET OF TWO VEHICLES

(71) Applicant: FLEXIS, BOULOGNE-BILLANCOURT (FR)

(72) Inventors: Benoit ALLARD, VILLIERS SAINT-FREDERIC (FR); Jerome CARIER, VILLIERS SAINT-FREDERIC (FR); Michael CAUDRON, VILLIERS SAINT-FREDERIC (FR); Gilles ENJOLRAS, VILLIERS SAINT-FREDERIC (FR)

(21) Appl. No.: 19/655,574

(22) Filed: Apr. 22, 2026

(30) Foreign Application Priority Data
Apr. 23, 2025 (FR) FR2504307

(51) Int. Cl. B62D 65/02; B60G 13/00; B60K 1/04; B60L 50/60; B62D 25/02; B62D 65/12

(52) U.S. Cl. CPC B62D 65/024; B60G 13/001; B60K 1/04; B60L 50/66; B62D 25/025; B62D 65/12; B60K 2001/0438

(57) ABSTRACT

A process for manufacturing a vehicle, wherein the vehicle includes a central unit including: a) a common central group of elements including a battery, and b) two side sill panels. The process includes a step of selecting the vehicle configuration between a first manufacturing configuration and a second manufacturing configuration, The width of the vehicle in the first manufacturing configuration is less than that of the vehicle in the second manufacturing configuration. The common central group of elements is identical in both manufacturing configurations. In the first manufacturing configuration, each side sill panel is fixed to one face of the battery. The vehicle in the second configuration further includes two interface pieces, each fixed between one of the side sill panels and the corresponding face of the battery.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### FIELD

This disclosure relates to a process for manufacturing a vehicle and a set of associated vehicles.

### BACKGROUND

Vehicles, in particular motor vehicles, have been known to be manufactured in different sizes, and in particular different widths, to suit different specific uses.

The design and manufacturing process of the vehicle is also specific to the size chosen, and in particular to the specific width chosen.

In particular, the various vehicle components are designed to take account of the constraints of this specific width.

This great diversity in components and manufacturing processes is therefore costly for manufacturers.

### SUMMARY

One of the aims of the disclosure is to make the manufacture of vehicles more economical.

In particular, one of the aims of the disclosure is to provide a process for manufacturing vehicles of different widths, while retaining a large number of parts in common.

To this end, the disclosure relates to a process for manufacturing a vehicle, wherein the vehicle comprises a central unit comprising:
a common central group of elements comprising at least:
   two longitudinal members, each extending along a longitudinal direction, the two longitudinal members being spaced apart in a transverse direction perpendicular to the longitudinal direction, and
   a battery arranged under the two longitudinal members and extending in the transverse direction between a right side and a left side, and - two side sill panels spaced apart in the transverse direction;
characterized in that the process comprises a step of selecting a configuration of the vehicle from between a first manufacturing configuration and a second manufacturing configuration,
in that the width of the vehicle in the first manufacturing configuration is less than that of the vehicle in the second manufacturing configuration, the width being measured in the transverse direction,
in that the central group of common elements is identical in the first and second manufacturing configurations,
in that, in the first manufacturing configuration, one of the side sill panels is fixed to the right side of the battery and the other is fixed to the left side of the battery, and
in that the vehicle in the second configuration additionally comprises two interface pieces, one fixed between one of the side sill panels and the right side of the battery, and the other fixed between the other side sill panel and the left side of the battery.

In other beneficial aspects of the disclosure, the process comprises one or more of the following features, taken in isolation or in any technically possible combination:
The difference in vehicle width between the first and second configurations is between 80mm and 160mm, preferably between 100mm and 130mm.
Each of the interface pieces is a bracket.
The vehicle comprises a rear unit comprising a common rear group of elements and two rear suspension arms,
   the common rear group of elements being identical in both the first and second manufacturing configurations,
   the two rear suspension arms being spaced apart in the transverse direction, the distance between the two rear suspension arms in the first manufacturing configuration being less than that in the second manufacturing configuration.
The rear unit comprises one two rear shock absorbers, each fixed to one of the rear suspension arms. The distance between the two rear shock absorbers in the first manufacturing configuration is less than that in the second manufacturing configuration.
The vehicle comprises a front unit comprising a common front group of elements, the common front group of elements being identical in both the first and second manufacturing configurations,
   in the first configuration, the front unit comprising two first front suspension arms, and
   in the second configuration, the front unit comprising two second front suspension arms, the second front suspension arms being longer than the first front suspension arms.
The vehicle comprises an instrument panel unit comprising a common instrument panel group of elements, the common instrument panel group of elements being identical in the first manufacturing configuration and in the second manufacturing configuration,
   the instrument panel group comprising a transversely extending instrument panel cross-member.
The instrument panel unit in the first configuration comprises at least one first structural element fixed to the instrument panel cross-member and the instrument panel unit in the second configuration comprises at least one second structural element fixed to the instrument panel cross-member, the second structural element being wider than the first structural element.
The disclosure further relates to a set comprising:
   a first vehicle manufactured according to the process described above, the first vehicle being in the first configuration, and
   a second vehicle manufactured according to the manufacturing process described above, the latter being in the second configuration; the width of the first vehicle being less than that of the second vehicle.

### BRIEF DESCRIPTION OF THE DRAWINGS

The disclosure will appear more clearly when reading the description that follows, given solely as a non-limiting example and made in reference to drawings wherein:

FIG. 1 is a schematic view of a set according to the disclosure comprising a first vehicle and a second vehicle,

FIG. 2 is a schematic view of the underside of the first vehicle and second vehicle in FIG. 1,

FIG. 3 is a perspective view of a central unit of the first vehicle in FIG. 1,

FIG. 4 is a schematic view of the fixing of a side sill panel in both the first vehicle and second vehicle,

FIG. 5 is a bottom view of a front unit of the first vehicle in FIG. 1, and

FIG. 6 is a bottom view of a rear unit and part of the central unit of the first vehicle in FIG. 1.

### DETAILED DESCRIPTION

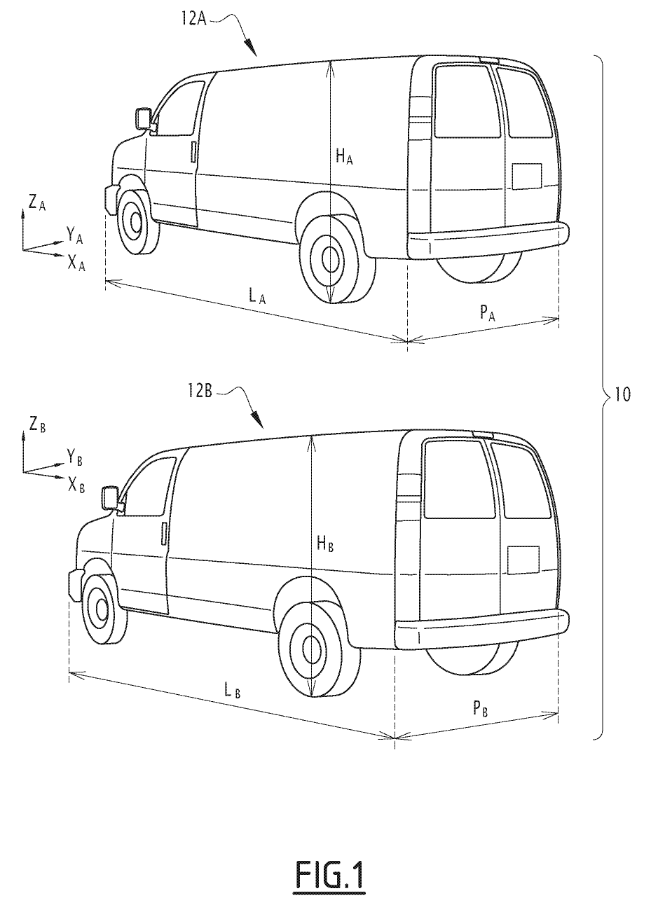

FIG. 1 illustrates a set 10 according to the disclosure.

The set 10 comprises a first vehicle 12A and a second vehicle 12B.

For the sake of clarity, in the remainder of the description, similar elements between the first vehicle 12A and the second vehicle 12B have the same reference numbers. Elements specific to the first vehicle 12A have the letter A at the end of their reference number, and those specific to the second vehicle 12B have the letter B.

The first vehicle 12A and second vehicle 12B are each, for example, a motor vehicle, particularly a commercial vehicle, and more specifically a light commercial vehicle.

In particular, each of the first vehicle 12A and the second vehicle 12B is intended for transporting goods, such as parcels, and/or passengers.

The first vehicle 12A and second vehicle 12B are each, for example, a van, as shown in FIG. 1.

Preferably, the first vehicle 12A and second vehicle 12B are each an electric vehicle.

For the sake of clarity, for both the first vehicle 12A and the second vehicle 12B, an orthonormal reference frame X_{A,B}Y_{A,B}Z_{A,B} comprising a longitudinal direction X_{A,B}, a transverse direction Y_{A,B} and a vertical direction Z_{A,B} is defined. The longitudinal direction X_{A,B} extends along the forward axis of the vehicle 12A,B and corresponds to a front-rear axis of the vehicle 12A,B. The transverse direction Y_{A,B} is perpendicular to the longitudinal direction X_{A,B} and corresponds to a left-right axis of the vehicle 12A,B. The vertical direction Z_{A,B} is perpendicular to the longitudinal direction X_{A,B} and to the transverse direction Y_{A,B} and corresponds to a down-up axis of the vehicle 12A,B.

The terms “up” and “down” are defined in relation to the vertical direction Z_{A,B} corresponding to the height of the vehicle 12A,B. The terms "left", "right", "front" and "rear" are defined in relation to the usual direction of travel of the vehicle 12A,B.

The first vehicle 12A is configured according to an initial manufacturing configuration.

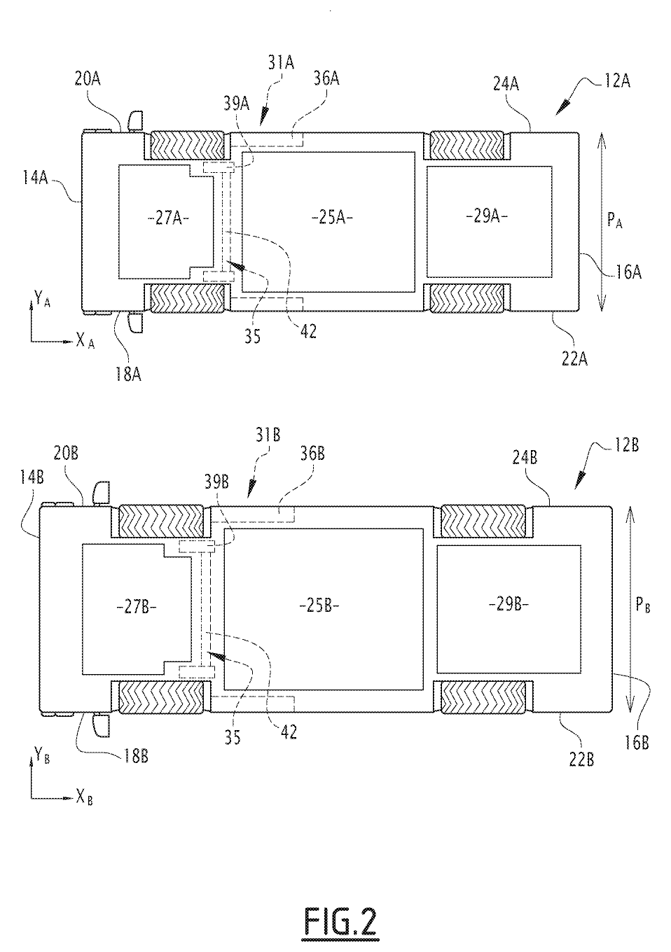

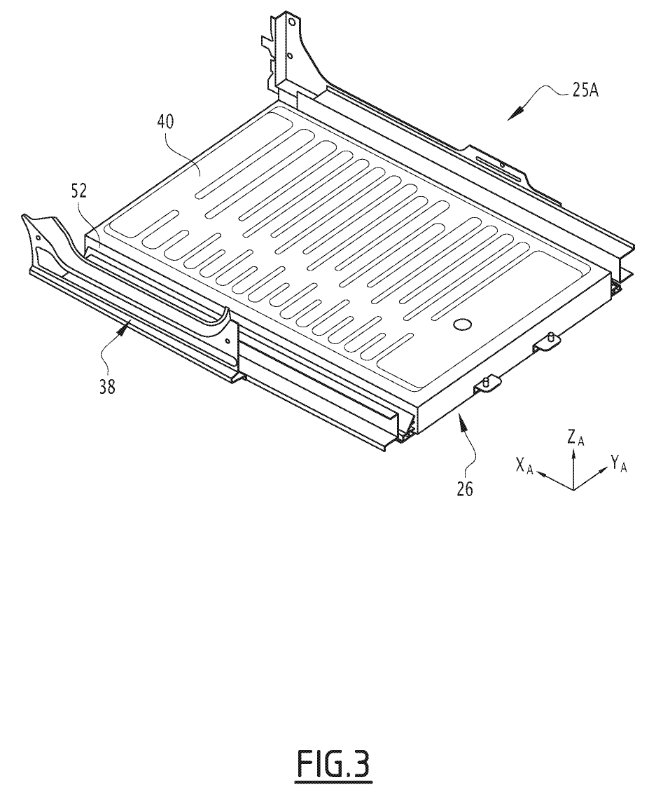

An example of the first vehicle 12A can be seen in FIGS. 1 and 2 and partially in FIGS. 3-6.

Preferably, the first vehicle 12A is a vehicle of a first size.

The first vehicle 12A, for example, has a width P_{A}, measured in the transverse direction Y_{A}, of between 1,850mm and 2,000mm, and more particularly between 1,910mm and 1,940mm, and even more particularly substantially equal to 1,920mm.

As can be seen in FIG. 2, the width P_{A} corresponds, for example, to the width across the wings, specifically the maximum between the width across the front wings and the width across the rear wings.

The width across the wings is defined here as the distance in the transverse direction Y_{A} between the two front wings 18A and 20A, the two rear wings 22A and 24A, and in particular between the right front wing 18A, the right rear wing 22A, the left front wing 20A, and the left rear wing 24A.

For example, the first vehicle 12A has a length L_{A}, measured along the longitudinal direction X_{A} between a front end 14A and a rear end 16A of the first vehicle 12A, of between 4,300mm and 5,000mm, and more particularly between 4,600mm and 4,700mm.

For example, the first vehicle 12A has a height H_{A}, measured in the vertical direction Z_{A}, between 1,700mm and 2,000mm.

The first vehicle 12A comprises a central unit 25A, and preferably at least one of the following: a front unit 27A, a rear unit 29A, or an instrument panel unit 31A.

The central unit 25A of the first vehicle 12A is, for example, arranged in the center of the first vehicle 12A, particularly in the longitudinal direction X_{A.}

The central unit 25A comprises a common central group 26 of elements and two side sill panels 28.

Optionally, the central unit 25A of the first vehicle 12A further comprises a first floor 37A.

The central group 26 comprises at least two longitudinal members 38 and a battery 40.

Optionally, but preferably, the central group 26 further comprises a cross-member 45.

The two longitudinal members 38 each extend in the longitudinal direction X_{A} and are spaced apart in the transverse direction Y_{A}.

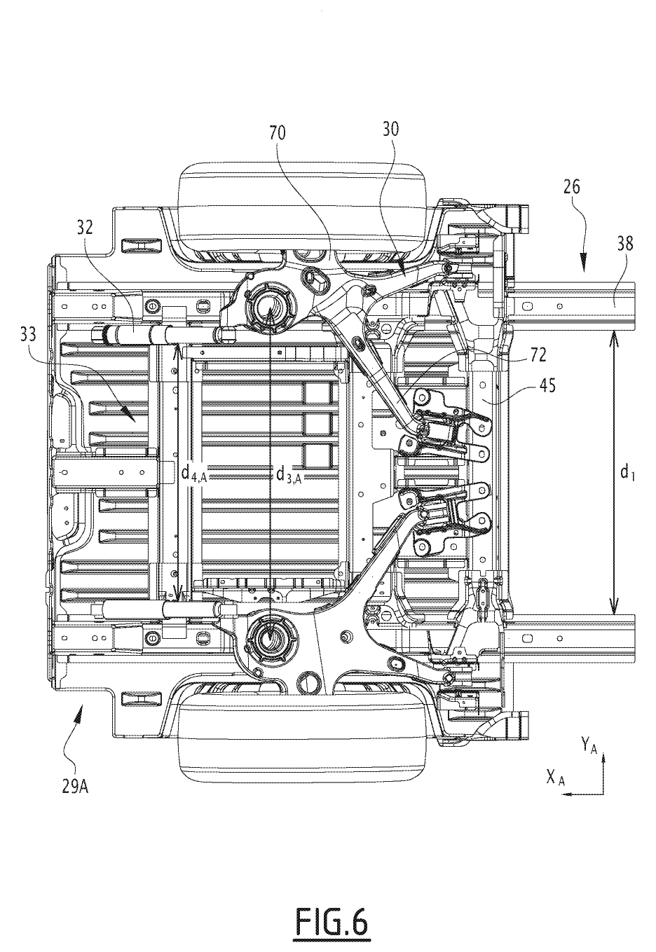

In particular, the two longitudinal members 38 correspond to a left longitudinal member and a right longitudinal member, as can be seen in FIG. 6.

The two longitudinal members 38 are spaced apart by a distance d₁, for example, measured in the transverse direction Y_{A}, of between 1,400mm and 1,900mm.

Each of the two longitudinal members 38 is, for example, a metal beam made of steel or an aluminium alloy.

Each of the two longitudinal members 38 has, for example, an open box section that is substantially square, with sides between 3cm and 15cm.

Each of the two longitudinal members 38 preferably defines an inner face 48 and an outer face 50 opposite each other in the transverse direction Y_{A}.

In particular, the internal faces 48 of two longitudinal members 38 face one another.

The battery 40 is located under the two longitudinal members 38.

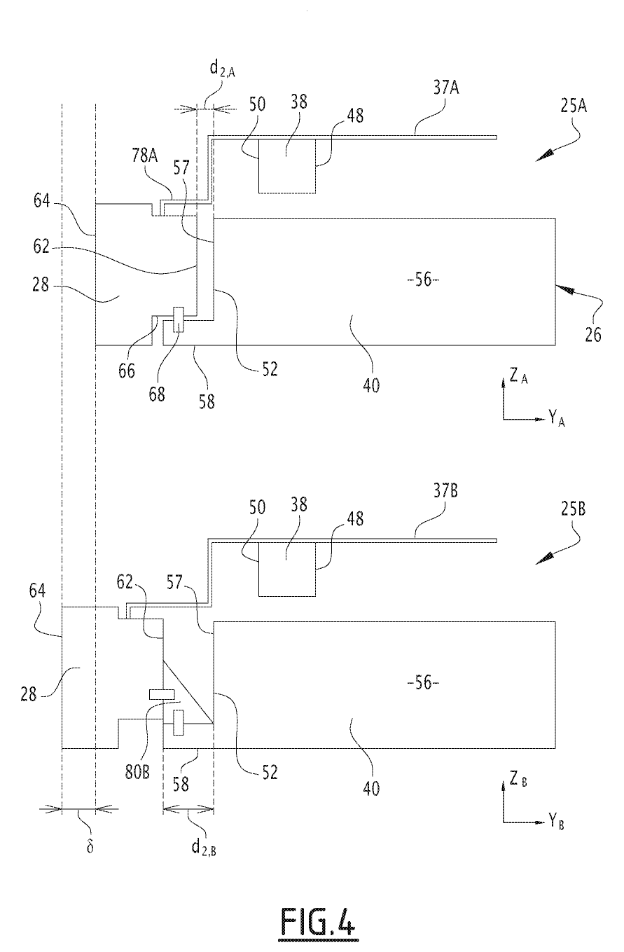

The battery 40 extends in the transverse direction Y_{A} between a right face 52 and a left face. Only the right face is visible in FIG. 4.

The battery 40 is preferably a traction battery, particularly with a terminal voltage of 800V.

The battery 40 comprises, for example, a protective casing 54 and electrochemical cell modules 56.

For example, the protective casing 54 defines an enclosure wherein the modules 56 are housed.

In particular, the protective casing 54 defines, for example, both the right face 52 and the left face.

For example, each of the right 52 and left faces comprises a flat, in particular vertical, portion 57 and a fixing lug 58 extending transversely outwards from the flat portion 57, as can be seen in FIG. 4.

As shown in FIG. 6, the cross-member 45 extends, for example, in the transverse direction Y_{A}, in particular between the two longitudinal members 38.

Preferably, the cross-member 45 connects the two longitudinal members 38.

The two side sill panels 28 are spaced apart according to the transverse Y direction Y_{A}.

In particular, the two side sill panels 28 correspond to a left side sill panel and a right side sill panel. Only the right side sill panel is visible in FIG. 4.

Each of the side sill panels 28 is preferably arranged at the front of the first vehicle 12A.

In particular, each of the side sill panels 28 is, for example, a component that ensures continuity between the bottom of the corresponding door and the underbody of the first vehicle 12A.

In particular, each of the side sill panels 28 defines an inner face 62 and an outer face 64 opposite one another in the transverse direction YA. The outer face 64 extends in particular towards the outside of the first vehicle 12A.

As illustrated in FIG. 4, the inner face 62, for example, is lower in height, measured in the vertical direction Z, than the outer face 64, so that each of the side sill panels 28, for example, defines a shoulder 66 between the two.

Each of the side sill panels 28 preferably extends opposite the outer face 50 of the corresponding longitudinal member 38.

More particularly, the inner face 62 of each of the side sill panels 28 preferably extends opposite the outer face 50 of the corresponding longitudinal member 38.

More precisely, the inner face 62 of each of the side sill panels 28 extends, for example, at a distance d₂,_{A} from the outer face 50 of the corresponding longitudinal member 38, and in particular from its flat portion 57, as can be seen in FIG. 4.

The distance d₂,_{A}, measured in particular in the transverse direction Y_{A}, is, for example, between 50mm and 150mm.

In the first manufacturing configuration (first vehicle 12A), one of the side sill panels 28, called the right side sill panel, is fixed to the right side 52 of the battery 40, as shown in FIG. 4. The other side sill panel 28, referred to as the left side sill panel, is fixed to the left face of battery 40.

For example, the right side sill panel 28, and in particular its shoulder 66, is fixed to the fixing lug 58 on the right face 52 of the battery 40.

Similarly, the left side sill panel 28, and in particular its shoulder 66, is, for example, fixed to the fixing lug 58 on the left side of the battery 40.

Preferably, each of the side sill panels 28 is fixed to the battery 40 by a fixing means 68, such as a screw for example.

Preferably, the first floor 37A is fixed in particular to the longitudinal members 38.

For example, the first floor 37A defines steps 78A, notably at the doors, and fixed to the corresponding side sill panel 28, as can be seen in FIG. 4.

The front unit 27A of the first vehicle 12A is, for example, arranged at the front of the first vehicle 12A.

In particular, the front unit 27A comprises a common front group 44 of elements and preferably the two first front suspension arms 34A.

Advantageously, the front group 44 comprises a plurality of components, in particular for steering, suspension and propulsion of the vehicle, including for example an engine, transmission, differential, steering, and front suspension.

Preferably, the front unit 27A comprises two first front suspension arms 34A, in particular advantageously providing a link between the front wheels and the chassis.

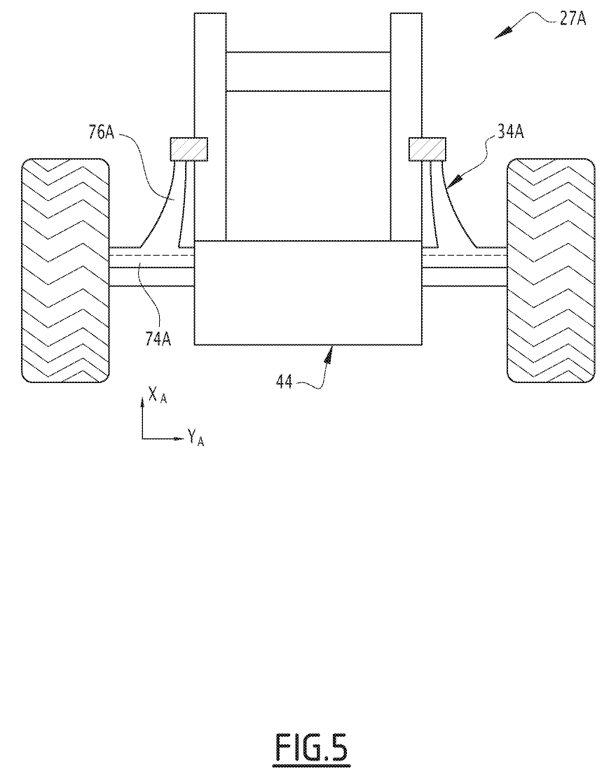

The two first front suspension arms 34A are, for example, spaced apart from each other in the transverse direction Y_{A}, as can be seen in FIG. 5.

In particular, the two first front suspension arms 34A correspond to a left front suspension arm and a right front suspension arm.

In the illustrated embodiment, each of the two first front suspension arms 34A is, in particular, a double-wishbone arm.

In other words, each of the two first front suspension arms 34A comprises an upper arm (not visible in the Figures) and a lower arm arranged one above the other in the vertical direction Z_{A}.

Each of the upper and lower arms preferably comprises a transverse arm 74A, for example fixed to the hub of the corresponding front wheel, and an inclined arm 76A, in particular forming a non-zero angle with the transverse arm 74A.

The rear unit 29A of the first vehicle 12A is, for example, arranged at the rear of the first vehicle 12A.

In particular, the rear unit 29A comprises a common rear component group 33, two rear suspension arms 30, and preferably also two rear shock absorbers 32.

Advantageously, the rear group 33 comprises a plurality of components, in particular for steering, suspension and propulsion of the vehicle, comprising, for example, a rear axle and a rear differential.

As can be seen in FIG. 6, the two rear suspension arms 30 preferably provide a link between the rear wheels and the chassis.

In particular, each of the two rear suspension arms 30 is fixed to one of the longitudinal members 38, for example, and preferably also to the cross-member 45.

In particular, the two rear suspension arms 30 correspond to a left rear suspension arm, in particular fixed to the left longitudinal member, and a right rear suspension arm, in particular fixed to the right longitudinal member.

Each of the rear suspension arms 30 comprises, for example, a main arm 70, in particular extending in the longitudinal direction X_{A}, and secondary arms 72.

For example, the two rear suspension arms 30 are spaced apart in the transverse direction Y_{A}.

In particular, the two rear suspension arms 30 are, for example, spaced apart by a distance d₃,_{A}, measured in the transverse direction Y_{A}, in particular between the two main arms 70. The distance d₃,_{A}, for example, is between 1,300mm and 1,800mm.

As can be seen in FIG. 6, each of the two rear shock absorbers 32 is fixed to one of the rear suspension arms 30.

For example, each of the two rear shock absorbers 32 is fixed to the rear end of the main arm 70 of the corresponding rear suspension arm 30.

Specifically, the two rear shock absorbers 32 correspond to a left rear shock absorber fixed to the left rear suspension arm and a right rear shock absorber fixed to the right rear suspension arm.

Each of the two rear shock absorbers 32, for example, is spaced apart from the other in the transverse direction Y_{A}.

In particular, the two rear shock absorbers 32 are for example spaced apart by a distance d₄,_{A}, in particular measured in the transverse direction Y_{A}, of between 1,200mm and 1,700mm.

More specifically, in the first manufacturing configuration (vehicle 12A), each of the rear shock absorbers 32 is arranged on the inner side of the corresponding longitudinal member 38, as can be seen in FIG. 6.

The instrument panel unit 31A of the first vehicle 12A comprises a common instrument panel group 35 of elements, and preferably at least one of: a first edge element 36A or two first structural elements 39A.

Preferably, the instrument panel group 35 comprises an instrument panel cross-member 42.

As shown in FIG. 2, the instrument panel cross-member 42 extends in the transverse direction Y_{A}, for example, between the right and left ends.

In particular, the instrument panel cross-member 42 is a structural element located behind the dashboard of the first vehicle 12A and serves as an anchoring point for various electrical and mechanical components located behind the dashboard, such as heating, ventilation and air conditioning (HVAC) systems, airbags, and on-board instruments, for example.

The instrument panel cross-member 42 is made of steel, for example.

Preferably, the instrument panel unit 31A comprises at least one first edge element 36A, and preferably a plurality of first edge elements. Each of the first edge elements 36A is chosen in particular from a door panel and an instrument panel.

Advantageously, the instrument panel unit 31A comprises two structural elements 39A: a left structural element and a right structural element.

Each of the first structural elements 39A, for example, is fixed to the instrument panel cross-member 42.

More specifically, the two first structural elements 39A are A-pillars, i.e. structural elements that support the windscreen of the first vehicle 12A.

The second vehicle 12B is configured according to a second manufacturing configuration.

An example of the second vehicle 12B is visible in FIGS. 1 and 2 and partially in FIG. 4.

Preferably, the second vehicle 12B is a vehicle of a second size, in particular one larger than that of the first vehicle 12A, as shown in FIG. 1.

The second vehicle 12B (in the second configuration) has a greater width P_{B} than the first vehicle 12A (in the first configuration).

In particular, the difference Δ between the width P_{A} of the first vehicle 12A and the width P_{B} of the second vehicle 12B is, for example, between 80mm and 160mm, preferably between 100mm and 130mm, and substantially equal to 120mm.

For example, the width P_{B}, measured in the transverse direction Y_{B}, is between 2,000mm and 2,100mm, and more particularly substantially equal to 2,040mm.

The width P_{B} corresponds, for example, to the width across the wings, and in particular to the maximum between the width across the front wings and the width across the rear wings.

For example, the second vehicle 12B has a length L_{B}, measured in the longitudinal direction X_{B} between a front end 14B and a rear end 16B of the second vehicle 12B, between 5,000mm and 6,000mm, and more particularly between 5,300mm and 5,600mm.

For example, the second vehicle 12B has a height H_{B}, measured in the vertical direction Z_{B}, between 2,200mm and 2,800mm.

The second vehicle 12B comprises a central unit 25B and preferably at least one of: a front unit 27B, a rear unit 29B, or an instrument panel unit 31B.

The central unit 25B of the second vehicle 12B is, for example, arranged in the center of the second vehicle 12B, particularly in the longitudinal direction X_{B.}

The central unit 25B comprises the common central group 26 of elements, the two side sill panels 28 and two interface pieces 80B.

Optionally, the central unit 25B of the second vehicle 12B further comprises a second floor 37B.

The central group 26 is identical in the first and second manufacturing configurations.

In other words, the elements of the central group 26 are identical in the second vehicle 12B as in the first vehicle 12A, and in particular are also arranged in the same way.

More specifically, in the second vehicle 12B, the central group 26 comprises the two longitudinal members 38 and the battery 40, which are identical and arranged in the same way as those described above for the first vehicle 12A.

Preferably, in the second vehicle 12B, the central group 26 further comprises a cross-member 45, in particular identical to and arranged in the same way as described above for the first vehicle 12A.

In the second vehicle 12B, the two side sill panels 28 are preferably identical to those used in the first vehicle 12A, but are transversely offset by the interface pieces 80B.

Each side sill panel 28 of the second vehicle 12B is, for example, transversely offset by a distance δ from those of the first vehicle 12A.

The distance δ is, for example, half the difference Δ between the width P_{A} of the first vehicle 12A and the width P_{B} of the second vehicle 12B.

In particular, in the second configuration (second vehicle 12B), the two side sill panels 28 are spaced apart in the transverse direction Y_{A} by a greater distance than in the first configuration, notably thanks to the interface pieces 80B.

As can be seen in FIG. 4, the inner face 62 of each side sill panel 28 extends, for example, to a distance d₂,_{B} from the outer face 50 of the corresponding longitudinal member 38, and in particular from its flat portion 57, the distance d₂,_{B} being greater than the corresponding distance d₂,_{A} of the first vehicle 12A.

The difference between these two distances d₂,_{B} is, for example, equal to the distance δ, and in particular half the difference Δ between the width P_{A} of the first vehicle 12A and the width P_{B} of the second vehicle 12B.

In the second manufacturing configuration (second vehicle 12B), one of the interface pieces 80B, called the right interface piece, is fixed between the right side sill panel 28 and the right face 52 of the battery 40, as shown at the bottom of FIG. 4. The other interface piece 80B, called the left interface piece, is fixed between the left side sill panel and the left face of the battery 40.

For example, each of the two interface pieces 80B is a bracket.

More specifically, each of the two interface pieces 80B is fixed between the corresponding side sill panel 28 and corresponding face of the battery 40.

For example, each of the two interface pieces 80B is fixed between the inner face 62 of the corresponding side sill panel 28 and the fixing lug 58 of the corresponding face of the battery 40, as shown in FIG. 4.

Preferably, each of the two interface pieces 80B is fixed to the battery 40 and the corresponding side sill panel 28 by fixing means 68, such as screws.

Preferably, the second floor 37B specifically is fixed to the longitudinal members 38 and is different from the first floor 37A of the first vehicle 12A.

For example, the second floor 37B is wider than the first floor 37A.

In particular, the difference in width between the first floor 37A and the second floor 37B is substantially equal to the difference Δ between the width P_{A} of the first vehicle 12A and the width P_{B} of the second vehicle 12B.

For example, the second floor 37A defines steps 78B, in particular at the doors, and in particular fixed to the corresponding side sill panel 28.

The front unit 27B of the second vehicle 12B is, for example, arranged at the front of the second vehicle 12B.

In particular, the front unit 27B comprises the common front group 44 of elements and, preferably, the two first front suspension arms 34B.

The front group 44 is identical in the first and second manufacturing configurations.

In other words, the elements of the front group 44 are identical in both the second vehicle 12B and the first vehicle 12A, and in particular are arranged in the same way.

Preferably, the front unit 27B of the second vehicle 12B comprises two second front suspension arms, which are different from the first front suspension arms 34A of the first vehicle 12A.

Preferably, the second front suspension arms are longer than the first front suspension arms 34A.

For example, the two second arms of the front suspension are spaced apart from each other in the transverse direction Y_{B}.

In particular, the two second front suspension arms correspond to the left and right front suspension arms.

For example, each of the two second front suspension arms is a double-wishbone arm.

Alternatively, each of the two second front-suspension arms comprises an upper arm and a lower arm arranged one above the other in the vertical direction Z_{B}.

Each upper and lower arm preferably comprises a transverse arm, for example fixed to the hub of the corresponding front wheel, and an inclined arm that forms a non-zero angle with the transverse arm.

The branches of the second front suspension arms are preferably longer than those of the first front suspension arms.

The rear unit 29B of the second vehicle 12B is, for example, arranged at the rear of the second vehicle 12B.

In particular, the rear unit 29B of the second vehicle 12B comprises the common rear group 33 of elements and preferably at least one of the two rear suspension arms 30 or the two rear shock absorbers 32.

The rear group 33 is identical in the first and second manufacturing configurations.

In other words, the elements of the rear group 33 are identical in the second vehicle 12B and in the first vehicle 12A, and are arranged in the same way.

In the second vehicle 12B, the two rear suspension arms 30 are preferably identical to those used in the first vehicle 12A, but are transversely offset.

Each rear suspension arm 30 of the second vehicle 12B is, for example, transversely offset by the distance δ from those of the first vehicle 12A.

In particular, in the second configuration (second vehicle 12B), the two rear suspension arms 30 are spaced apart from each other in the transverse direction Y_{A} by a greater distance than in the first configuration, thanks in particular to the interface pieces 80B.

In the second configuration (second vehicle 12B), the two rear-suspension arms 30 are, for example, spaced apart by a distance d₃,_{B}, measured in the transverse direction Y_{A}, the distance d₃,_{B} being greater than the corresponding distance d₃,_{B} of the first vehicle 12A. The difference between these two distances is, for example, equal to the distance δ, and in particular half the difference Δ between the width P_{A} of the first vehicle 12A and the width P_{B} of the second vehicle 12B.

In the second vehicle 12B, the two rear shock absorbers 32 are preferably identical to those used in the first vehicle 12A, but are transversely offset.

Each rear shock absorber 32 of the second vehicle 12B is, for example, transversely offset by the distance δ from those of the first vehicle 12A.

In particular, in the second configuration (second vehicle 12B), the two rear shock absorbers 32 are for example spaced apart by a distance d₄,_{B}, in particular measured in the transverse direction Y_{B}, the distance d₄,_{B} being greater than the corresponding distance d₄,_{A} of the first vehicle 12A. The difference between these two distances is, for example, equal to the distance δ, and in particular half the difference Δ between the width P_{A} of the first vehicle 12A and the width P_{B} of the second vehicle 12B.

More specifically, in the second manufacturing configuration (second vehicle 12B), each of the rear shock absorbers 32 is arranged on the outer side of the corresponding longitudinal member 38.

Preferably, the instrument panel unit 31B of the second vehicle 12B comprises at least one second edge element 36B, and preferably a plurality of second edge elements 36B, in particular different from the first edge elements 36A of the first vehicle 12A.

For example, each second edge element 36B has a greater width than a corresponding first edge element 36A. Each of the second edge elements 36B is chosen in particular from a door panel and an instrument panel.

Advantageously, the instrument panel unit 31B further comprises two second structural elements 39B, and specifically, a second left structural element and a second right structural element.

These two second structural elements 39B of the instrument panel unit 31B of the second vehicle 12B are particularly different from the first structural elements 39A of the first vehicle 12A.

For example, each second structural element 39B is wider than a corresponding first structural element 39A.

More specifically, both second structural elements, 39B, are A-pillars.

A process for manufacturing a vehicle 12A, 12B will now be described.

Firstly, the process comprises a step of selecting either the first or the second manufacturing configuration.

In one case, the first manufacturing configuration is chosen.

The method comprises a step of supplying the components, in particular the common central group 26 of elements, the two side sill panels 28, and preferably also a first floor 37A.

Preferably, this step further comprises supplying the common front group 44 of elements and, for example, the two first front suspension arms 34A.

Preferably, this step further comprises supplying the common rear group 33 of elements and, for example, at least one of two rear suspension arms 30 and two rear shock absorbers 32.

Preferably, this step further comprises providing the common instrument panel group 35 of elements and, for example, at least one of a first instrument panel element 36A and two first structural elements 39A.

The process then comprises a step of assembling the components provided, in particular so as to obtain the first vehicle 12A in the first configuration.

For example, this step of assembly comprising fixing the side sill panels 28 to the battery 40, to form the central unit 25A of the first vehicle 12A.

In particular, during this step, one of the side sill panels 28 is fixed to the right side 52 of the battery 40 and the other side sill panel 28 is fixed to the left side of the battery 40.

For example, this step of assembly further comprises fixing the first floor 37A onto the longitudinal members 38.

Preferably, the step of assembly further comprises fixing the two first front suspension arms 34A, in particular so as to form the front unit 27A of the first vehicle 12A. For example, the step of assembly further comprises fixing the two rear suspension arms 30 so that they are spaced apart from each other in the transverse direction Y_{A} by a distance d₃,_{A}.

Preferably, the step of assembly also comprises fixing the two rear shock absorbers 32 to the rear suspension arms 30, for example so as to be spaced apart in the transverse direction Y_{A} by a distance d₄,_{A}.

Preferably, the step of assembly further comprises fixing the first edge element(s) 36A, in particular to the instrument panel cross-member 42.

Preferably, the step of assembly further comprises fixing the first structural elements 39A.

Advantageously, the process further comprises a step of adjusting the position of the front and rear wheels, and in particular their camber.

Thus, a first car 12A in the first manufacturing configuration is obtained.

In another case, the second manufacturing configuration is chosen during the step of selection.

The method in this case further comprises a step of supplying the components, and in particular the common central group 26 of elements, the two side sill panels 28, two interface pieces 80B, and preferably also a second floor 37B.

Preferably, this step further comprises supplying the common front group 44 of elements and the two second front suspension arms 34B.

Preferably, this step further comprises supplying the common rear group 33 of elements and, for example, at least one of two rear suspension arms 30 and two rear shock absorbers 32.

Preferably, this step further comprises the provision of the common instrument panel group 35 of elements and, for example, at least one of the following: a second edge element 36B or two second structural elements 39B.

The process then comprises a step of assembling the components supplied together, in particular so as to obtain the second vehicle 12B in the second configuration.

For example, this step of assembly comprises fixing the interface pieces 80B between the side sill panels 28 and the battery 40, to form the central unit 25B of the second vehicle 12B.

In particular, during this step, one of the interface pieces 80B is fixed between the right side sill panel 28 and the right face 52 of the battery 40 and the other of the interface pieces 80B is fixed between the left side sill panel and the left face of the battery 40.

For example, the step of assembly further comprises fixing the second floor 37B, in particular to the longitudinal members 38.

Preferably, the step of assembly further comprises fixing the two second front suspension arms, in particular so as to form the front unit 27B of the second vehicle 12B.

For example, the step of assembly also comprises fixing the two rear suspension arms 30, for example so that they are spaced apart in the transverse direction Y_{B} by a distance d₃,_{B}.

Preferably, the step of assembly further comprises fixing the two rear shock absorbers 32 to the rear suspension arms 30, for example so as to be spaced apart in the transverse direction Y_{B} by a distance d₄,_{B}.

Preferably, the step of assembly further comprises fixing the second edge element(s) 36B, in particular to the instrument panel cross-member 42.

Preferably, the step of assembly further comprises fixing the second structural elements 39B.

Advantageously, the process further comprises a step of adjusting the position of the front and rear wheels, and in particular their camber.

A second car 12B is thus obtained under the second manufacturing configuration.

Such a manufacturing process is particularly advantageous.

In particular, such a process makes it possible to obtain two vehicles 12A, 12B of different widths from a large number of common components.

Such a process makes the first vehicle 12A and the second vehicle 12B more economical.

What is claimed is:

1. A method for manufacturing a vehicle, wherein the vehicle comprises a central unit comprising:
a) a common central group of elements comprising:
i. two longitudinal members, each extending in a longitudinal direction, the two longitudinal members being spaced apart in a transverse direction perpendicular to the longitudinal direction; and
ii. a battery arranged under the two longitudinal members and extending in the transverse direction between a right face of the battery and a left face of the battery; and
b) two side sill panels spaced in the transverse direction,
wherein the method comprises selecting a configuration of the vehicle from between a first manufacturing configuration and a second manufacturing configuration,
wherein a width of the vehicle in the first manufacturing configuration is less than that of the vehicle in the second manufacturing configuration, the width being measured in the transverse direction,
wherein the common central group of elements is identical in the first and second manufacturing configurations,
wherein, in the first manufacturing configuration, one of the two side sill panels is fixed to a right side of the battery and the other one of the two side sill panels is fixed to a left side of the battery, and
wherein the vehicle in the second manufacturing configuration comprises two interface pieces, one of the two interface pieces being fixed between one of the two side sill panels and the right face of the battery and the other one of the two interface pieces being fixed between the other one of the two side sill panels and the left face of the battery.

2. The method according to claim 1, wherein a difference in the width of the vehicle between the first and second manufacturing configurations is between 80mm and 160mm.

3. The method according to claim 2, wherein the difference in the width of the vehicle between the first and second manufacturing configurations is between 100mm and 130mm.

4. The method according to claim 1, wherein each of the two interface pieces is a bracket.

5. The method according to claim 1, wherein the vehicle comprises a rear unit comprising a common rear group of elements and two rear suspension arms, the common rear group of elements being identical in both the first and second manufacturing configurations, the two rear suspension arms being spaced apart in the transverse direction, a distance between the two rear suspension arms in the first manufacturing configuration being less than that in the second manufacturing configuration.

6. The method according to claim 5, wherein the rear unit comprises two rear shock absorbers each fixed to one of the two rear suspension arms, a distance between the two rear shock absorbers in the first manufacturing configuration being less than that in the second manufacturing configuration.

7. The method according to claim 1, wherein the vehicle comprises a front unit with a common front group of elements that is identical in the first manufacturing configuration and in the second manufacturing configuration,
in the first manufacturing configuration, the front unit comprising two first front suspension arms, and
in the second manufacturing configuration, the front unit comprises two second front suspension arms, which are longer than the two first front suspension arms.

8. The method according to claim 1, wherein the vehicle comprises an instrument panel unit comprising a common instrument panel group of elements, the common instrument panel group of elements being identical in the first manufacturing configuration and in the second manufacturing configuration, the instrument panel unit comprising a transversely extending instrument panel cross-member.

9. The method according to claim 8, wherein the instrument panel unit in the first manufacturing configuration comprises at least one first structural element fixed to the transversely extending instrument panel cross-member, the instrument panel unit in the second manufacturing configuration comprising at least one second structural element fixed to the transversely extending instrument panel cross-member, the at least one second structural element being wider than the at least one first structural element.

10. A set comprising:
a first vehicle manufactured according to the method of claim 1, the first vehicle being in the first manufacturing configuration; and
a second vehicle manufactured according to the method of claim 1, the second vehicle being in the second manufacturing configuration,
wherein a width of the first vehicle is less than a width of the second vehicle.
